(19) United States
(12) Patent Application Publication
(10) Pub. No.: US 2026/0310558 A1
(43) Pub. Date: Oct. 8, 2026

(54) SNAPSHOT ACTIVATION FOR STORAGE REPLICATION

(71) Applicant: Dell Products L.P., Round Rock, TX (US)

(72) Inventors: Sandeep Chandrashekhara, Shrewsbury, MA (US); Ramesh Doddaiah, Westborough, MA (US); Mohammed Asher, Bangalore (IN); Mark Halstead, Holliston, MA (US)

(73) Assignee: Dell Products L.P., Round Rock, TX (US)

(21) Appl. No.: 19/098,099

(22) Filed: Apr. 2, 2025

(51) Int. Cl. G06F 11/14

(52) U.S. Cl. CPC G06F 11/1466; G06F 11/1469

(57) ABSTRACT

One or more aspects of the present disclosure relate to optimizing snapshot creation in active-active storage replication environments. The system implements a two-phase snapshot process that significantly reduces the impact on IO operations. During the create phase, volumes are prepared, and pending snapshot indications are set in fast-access memory on both storage arrays without requiring an extended consistency window. The activate phase utilizes a shortened consistency window to flush IO operations and set global activation indicators. Snapshot activation completes asynchronously in the background while preserving existing data before accepting new writes. The system intercepts write operations during activation, coordinating between arrays to maintain consistency. This approach enables the creation of identical point-in-time snapshots across replicated arrays while minimizing disruption to ongoing operations through reduced dependency on extended consistency windows. The system provides efficient snapshot management without compromising data integrity or write-order consistency across the active-active replication environment.

### BACKGROUND

Storage systems employ active-active remote replication configurations where multiple storage arrays can simultaneously receive write operations while maintaining synchronized data between them. In these environments, each storage array acts as both a primary storage device, receiving local write operations, and a replication target for its peer array. Point-in-time snapshots provide consistent copies of data across replicated volumes, enabling critical functions like database restartability and data protection. An Enginuity Consistency Assist (ECA) mechanism facilitates write-order consistency by temporarily queuing incoming write operations at the host adapter level while snapshot operations are completed.

### SUMMARY

One or more aspects of the present disclosure relate to optimizing snapshot creation in active-active storage replication environments. In embodiments, volumes for snapshot creation on first and second storage arrays are prepared by setting a pending indication in memory. Additionally, input/output (IO) operations are flushed on both storage arrays. A global indication signaling snapshot activation is set. Snapshot activation is completed in a background process. Further, existing data is preserved before accepting new write operations during snapshot activation.

In embodiments, data structures for snapshot creation can be initialized on both storage arrays.

In embodiments, write operations to the volumes can be intercepted during snapshot activation.

In embodiments, an activation request can be sent to the second storage array upon receiving a write operation at the first storage array.

In embodiments, snapshot data structures for each volume having the pending indication can be initialized.

In embodiments, the pending indication for each volume can be cleared after completing snapshot activation for that volume.

In embodiments, the global indication can be cleared after completing snapshot activation for all volumes.

In embodiments, synchronous write intercepts can be performed before accepting a first write operation on at least one subject volume of the volumes to initiate a pending snapshot activation.

In embodiments, write operations can be handled asynchronously after snapshot activation by preserving old data before applying new data.

In embodiments, the pending indication and global indication can be checked before accepting write operations. The pending indication can correspond to a local pending indication, and checking the pending indication and the global indication can include referring to the global indication in response to determining whether the local pending indication is set.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of a communications network, including a storage array and a remote data facility (RDF) in accordance with embodiments of the present disclosure.

FIG. 4 is a block diagram of a controller in accordance with embodiments of the present disclosure.

FIG. 5 is a flow diagram of a method for optimizing snapshot creation in active-active storage replication environments per embodiments of the present disclosure.

### DETAILED DESCRIPTION

Modern organizations, such as financial institutions, rely on active-active remote replication configurations in their storage systems to maintain synchronized data across multiple storage arrays. For example, a global bank may have two data centers that simultaneously process transactions while keeping customer account data synchronized between locations. An Enginuity Consistency Assist (ECA) mechanism facilitates write-order consistency by temporarily queuing incoming write operations at the host adapter level while snapshot operations are completed. Point-in-time snapshots provide consistent copies of data across replicated volumes, enabling critical functions like transaction logging and regulatory compliance.

Creating consistent snapshots across active-active replicated storage arrays presents significant performance challenges for financial institutions. For instance, during snapshot activation, critical transaction processing writes must be held at the storage level for prolonged periods within the ECA window to ensure dependent write-order consistency across volumes in the replication group. In a banking environment where thousands of transactions occur per second, maintaining ECA on both sides of the replication group significantly degrades IO response times during consistent snapshot operations.

Embodiments of the present disclosure provide an optimized two-phase approach for creating and activating consistent snapshots across active-active replicated storage arrays used in financial environments. Consider a bank's trading platform that requires frequent point-in-time snapshots. The first phase, the create command, prepares volumes for snapshot creation by setting pending snapshot indications in fast-access memory on both storage arrays without requiring an ECA window. This preparation work includes initializing data structures and setting local pending indications for each volume containing trade data.

The second phase, the activate command, utilizes a significantly shortened ECA window compared to previous approaches. During activation, the system flushes outstanding IO operations on both arrays and sets a global indication signaling snapshot activation. For example, when creating an end-of-day snapshot of all trading positions, the actual snapshot activation process is completed asynchronously in the background while carefully preserving existing data before accepting new trade write operations.

Write operations during the activation process are managed through a sophisticated mechanism that checks both pending and global snapshot indications before accepting writes. The system intercepts writes to volumes with pending snapshots and coordinates activation requests between arrays when needed. For intercepted writes, such as updates to customer account balances, the system performs synchronous write intercepts to initialize snapshot data structures and clear pending bits.

The background activation process systematically initializes necessary data structures for each volume and clears pending indications once complete. This approach significantly reduces the duration of write operation holds compared to previous methods that performed all activation tasks within the ECA window. After background initialization completes, writes are handled asynchronously, with the embodiments preserving old data as deltas before applying new data to backend tracks, which is critical for maintaining accurate historical records of financial transactions.

By moving most snapshot initialization work outside the ECA window and optimizing the activation process, embodiments of the present disclosure enable financial institutions to create consistent snapshots with minimal impact on transaction processing performance while maintaining data integrity across the replicated arrays. The shortened ECA window and background initialization process provide efficient snapshot management without compromising write-order consistency or degrading IO response times for time-sensitive financial operations.

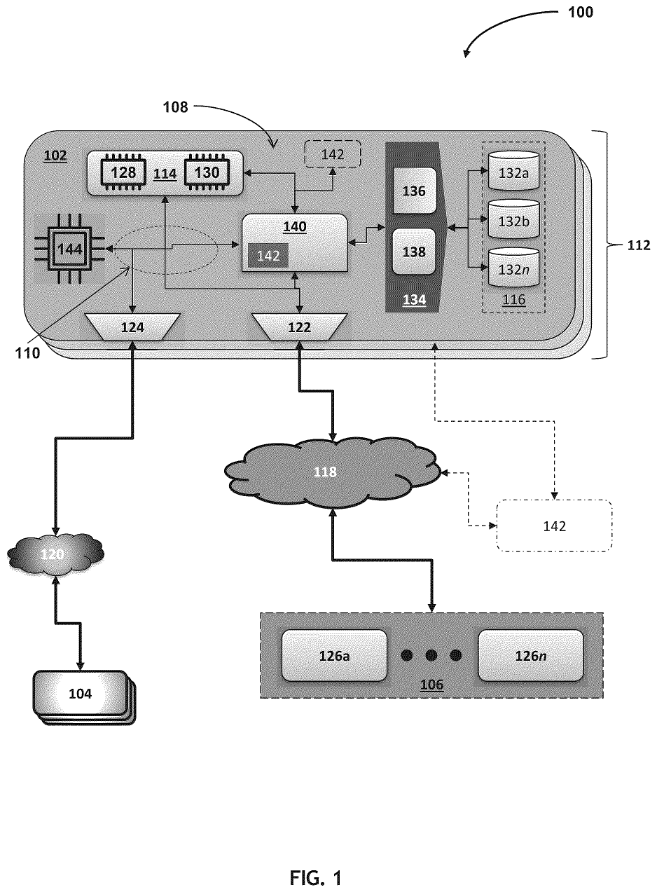

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110, such as Fibre Channels, buses, and communication modules, that communicatively couple the components 108. Furthermore, the distributed network environment 100 can define an array cluster 112, comprising the storage array 102 and one or more additional storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Furthermore, the network 118 or the remote network 120 can have a network architecture that enables networked devices to send and receive electronic communications using a specific communications protocol. For example, the network architecture can define a storage area network (SAN), a local area network (LAN), a wide area network (WAN) (e.g., the Internet), an Explicit Congestion Notification (ECN)-enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Furthermore, the storage array 102 can connect to the network 118 or a remote network 120 via one or more network interfaces. The network interface can include a wired or wireless connection interface, a bus, a data link, and the like. For example, a host adapter (HA 122), such as a Fibre Channel Adapter (FA) and the like, can connect the storage array 102 to the network 118 (e.g., a Storage Area Network or SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, and infrared light beams, among others. The communication nodes can also include switching equipment, phone lines, repeaters, multiplexers, and satellites. Furthermore, the network 118 or remote network 120 can include a network bridge that enables cross-network communication between, for example, the network 118 and the remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Furthermore, the IO messages can include metadata that defines performance requirements according to a service level agreement (SLA) between hosts 106 and the storage array provider.

In embodiments, the storage array 102 can include a memory 114, such as volatile or nonvolatile memory. Furthermore, volatile and nonvolatile memory can include random-access memory (RAM), dynamic random-access memory (DRAM), static random-access memory (SRAM), and the like. Moreover, each memory type can have distinct performance characteristics, such as speed corresponding to reading or writing data. For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and one or more GPUs (graphical processing units).

Additionally, the storage array 102 can provide its distributed storage services using persistent storage 116. For example, the persistent storage 116 can include multiple thin-data devices (TDATs) such as persistent storage drives 132a-n. Furthermore, each TDAT can have distinct performance capabilities, such as read/write speeds, similar to those of hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136), such as a storage device controller, a flash drive interface 138, and the like, that control access to the array's persistent storage 116, including storage devices 132a-n.

Likewise, the storage array 102 can include an Enginuity Data Services processor (EDS 140) that can manage access to the array's memory 114. Furthermore, the EDS 140 can perform one or more memory and storage self-optimizing operations (e.g., utilizing one or more machine learning techniques) that enable rapid data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote or distributed storage services by virtualizing the storage array's memory and storage resources (memory 114 and persistent storage 116, respectively).

In embodiments, the storage array 102 can also include a controller 142 (e.g., a management system controller) that resides either externally from or within the storage array 102 and one or more of its components 108. When external to the storage array 102, the controller 142 can communicate with the storage array 102 using any known communication protocol or connection. For example, the communication connections can include a serial port, parallel port, or a network interface card (e.g., Ethernet). Furthermore, the controller 142 can include logic or circuitry that performs one or more storage-related services. For example, the controller 142 can have an architecture designed to manage the storage array's computing, processing, storage, and memory resources as described in greater detail herein.

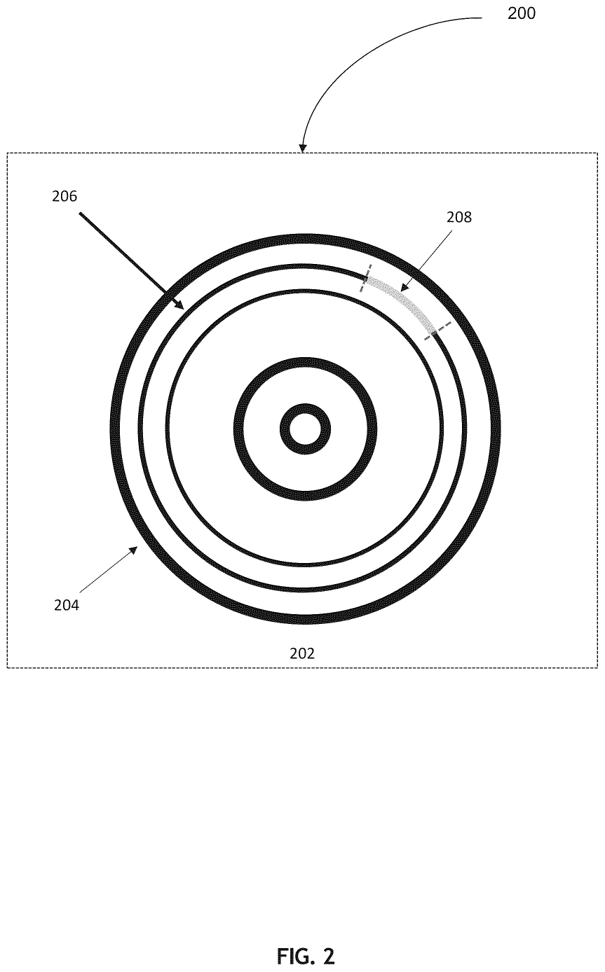

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, such as a client machine 126a, with a virtual storage device (e.g., a thin device (TDEV)) that logically represents zero or more portions of each storage device 132a-n. For example, the EDS 140 can establish a logical track using zero or more physical address spaces from each of the storage devices 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID), such as a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include a hard disk drive (HDD) 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can assign a corresponding logical block address (LBA) to each slice or portion. The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to one or more of the persistent storage 116 or portions thereof (e.g., tracks and address spaces).

As stated herein, the persistent storage 116 can have distinct performance capabilities. For example, an HDD architecture is known to skilled artisans as being slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory and storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory and storage resources based on the anticipated volume of IO messages associated with each SL tier and the memory hierarchy.

For example, the EDS 140 can establish a hierarchy that includes one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, and Gold SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

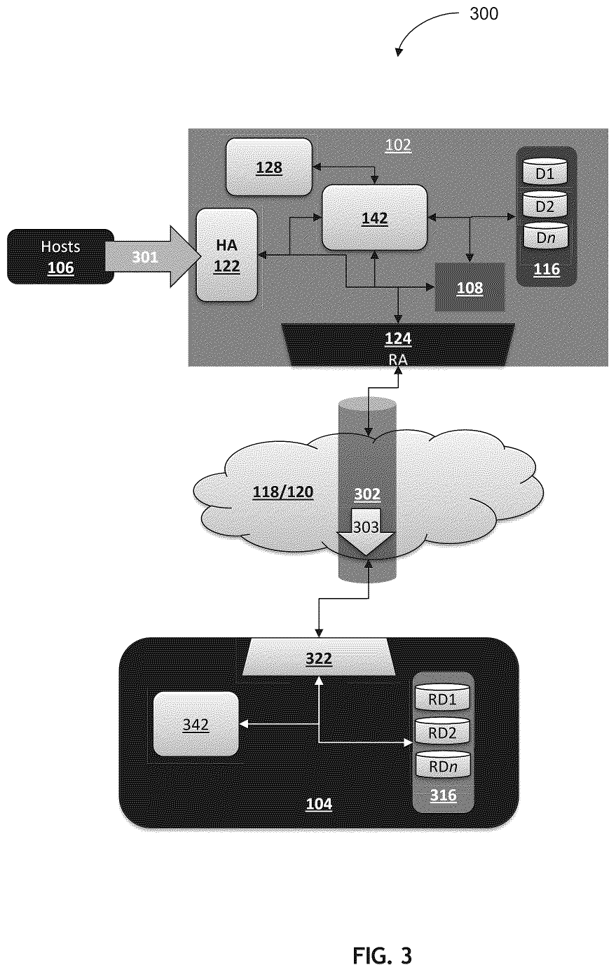

Regarding FIG. 3, a distributed network environment 300 can be substantially similar to the distributed network environment 100 of FIG. 1. For instance, the distributed network environment 300 can include a storage array 102, remote array 104, and hosts 106. In embodiments, the storage array 102 can receive an input/output (IO) workload 301 from the hosts 106. The storage array 102 can include a host adapter (HA) 122 that processes the IO workload 301. The HA 122 can classify the IO workload 301 and its IO operations. The classification can include identifying the type of IO operation (e.g., read, write, replication), IO size, and associating each operation with a specific service level (e.g., Diamond, Platinum, Gold, Silver, and Bronze).

In embodiments, a service level agreement (SLA) can define the level of service expected from a storage array (e.g., the storage array 102) or a remote system or array (e.g., the remote data facility (RDF) 104). Specifically, the SLA can define performance metrics for processing IO workloads (e.g., the IO workload 301) and their respective IO operations. The performance metrics can include throughput (e.g., data transfer rate in megabytes per second (MB/s) or gigabytes per second (GB/s)), Input/Output Operations Per Second (IOPS) (e.g., the minimum read and write operations the storage array should be able to handle per second), and latency (e.g., the maximum acceptable delay for an IO operation to be completed).

Furthermore, the SLA can categorize IO operations into distinct priority levels, such as Diamond, Platinum, Gold, Silver, and Bronze Service Levels. Additionally, critical operations that affect core business functions might be classified at a higher priority level, requiring faster throughput and lower latency. Accordingly, the SLA can specify different performance metrics for each priority level, ensuring that critical operations are given priority over less critical tasks.

In embodiments, IO operations critical to business operations, such as financial transactions, real-time data analytics, or emergency response systems, can have a high priority level (e.g., Diamond or Platinum). The storage array 102 can give these high-priority level IO operations preferential access to resources (e.g., faster CPUs, more cache memory, and quicker storage media). Essential but not critical IO operations, such as batch processing jobs, standard database queries, or internal data transfers, can have a medium priority level (e.g., Gold or Silver). The storage array 102 can provide these medium-priority IO operations with adequate resources to ensure good performance without preempting resources from higher-priority tasks. Non-critical IO operations that can tolerate delays, such as backup operations, data archiving, or other maintenance-related tasks, can have a low priority level (e.g., Bronze). The storage array 102 can allocate resources not used by higher-priority tasks to these low-priority IO operations. Furthermore, the storage array 102 can pause or slow down resource allocations for these low-priority IO operations during periods of high system load to preserve performance for higher-priority IO operations.

In embodiments, the HA 122 can parse information from each IO operation in the IO workload 301. For example, each IO operation can include information such as the target device (TDEV), which specifies the virtual volume on which the data corresponding to each IO operation resides, the LBA (Logical Block Address), which indicates the starting block address where the data needs to be read from or written to, and Logical Block Count (LBC), which specifies the count of logical blocks that the IO operation is intended to access starting from the specified LBA.

Using the LBA and LBC, the controller 142 maps these logical addresses to physical storage locations. This mapping can involve consulting a mapping table that translates logical block addresses into physical block addresses or locations on the storage media, such as persistent storage 116. Once the controller 142 has mapped the LBA to a specific physical location, it identifies the corresponding TIDs. These TIDs represent specific tracks on the disks where the data blocks are physically stored or need to be written. The TID helps locate the data and plays a crucial role in optimizing disk operations by allowing the controller to manage and access tracks efficiently.

In embodiments, the controller 142 uses metadata associated with each TID to manage data more effectively. This metadata can include data protection levels, compression settings, and deduplication information. It also includes the status of the data, such as whether it is clean or dirty (modified but not yet written to disk). Based on the TIDs and the associated metadata, the controller 142 can decide to cache certain data blocks in the array's GM 128 to speed up future accesses. This decision is influenced by factors such as the frequency of access (hot data) and the IO patterns observed. With the TIDs identified and any necessary data cached, the controller 142 executes the IO operation. For read operations, it retrieves the data from the specified tracks and sends it back to the host. For write operations, it writes the data to the designated tracks and updates the metadata accordingly.

In embodiments, the storage array (e.g., “local” or “source” array) 102 can be paired with a secondary storage array (e.g., “remote,” “target,” or “RDF” array) 104 located at a different geographical site. For instance, the storage array 102 can establish an RDF link 302 with the RDF array 104 over a network 118/120. Accordingly, the storage array 102 can use the RDF array 104 as a data replication and disaster recovery solution, ensuring data availability and integrity across geographically dispersed locations. Accordingly, the RDF 104 can receive replication workloads 303, which include data and operations mirrored from the primary storage array 102 to the RDF 104.

The storage array 102 can also designate specific logical volumes or devices, representing one or more portions of the storage devices D1-n in the storage array's persistent storage 116, for replication. In particular, the storage array 102 can logically group the designated volumes or devices for replication. For example, the storage array 102 can configure each group with specific replication properties, such as synchronous or asynchronous replication, depending on the required data protection level and performance impact.

In synchronous replication, every write IO operation from a host (e.g., one of the hosts 106) to the primary storage array (e.g., the storage array 102) is simultaneously replicated to the secondary storage array (e.g., the RDF 104). Further, the primary storage array waits for an acknowledgment from the secondary array before confirming the write IO operation to the host. Accordingly, synchronous replication guarantees that both arrays are always in sync and ensures zero data loss.

Asynchronous replication involves replicating data to the secondary array with a slight delay. The primary array does not wait for an acknowledgment for each write operation, which minimizes the impact on performance. This method is suitable for situations where some data loss is tolerable in exchange for higher throughput and lower latency.

In embodiments, the local storage array 102 and the remote storage array 104 can include respective controllers 142/342. The controllers 142/342 implement a two-phase snapshot process that coordinates the creation and activation of consistent snapshots across active-active remote replication while minimizing IO impact through shortened Enginuity Consistency Assist (ECA) windows and background initialization. The controllers 142/342 work together to manage pending snapshot indications in fast-access memory and global activation flags, enabling efficient write handling during snapshot operations while maintaining data consistency between the arrays. This coordinated approach allows the controllers to preserve point-in-time copies while significantly reducing the performance impact compared to previous approaches that required an extended ECA window.

Accordingly, the remote array 104 stores snapshots (e.g., in one or more portions of the storage devices RD1-n in the remote storage array's persistent storage 316) through a sophisticated delta-based system where current data is preserved as snapshot deltas during write intercepts. When a write operation occurs, the controllers 142/342 first preserve the existing data before applying new writes to the backend tracks. The snapshot storage process begins during the create command phase, where an entry is added to a snapshot table to store the snapshot name and track the point-in-time copy. During activation, the controllers 142/342 initialize the necessary data structures for each volume that has a pending snapshot indication. The controllers 142/342 also manage the preservation of old data as deltas before applying new data to the backend tracks, allowing efficient storage while maintaining point-in-time consistency. This approach enables the controllers 142/342 to maintain snapshot data integrity while minimizing the impact on ongoing write operations and optimizing storage space utilization.

The ECA window represents a period during which write operations are queued at the host adapter level without being acknowledged, ensuring consistent write order across volumes in the replication group. During this window, incoming writes are still received by the array but are queued rather than being processed immediately. The array does not acknowledge these writes to the host until the window closes, effectively creating a consistent point-in-time image across all volumes

In the previous approach, these windows were significantly longer because snapshot activation required processing each volume sequentially during the consistency window. As described herein, the controllers 142/342 reduce the window duration by moving bulk snapshot initialization outside the consistency window during the create phase, using a shortened window only to flush outstanding IOs and set global activation flags, and deferring full snapshot activation to background processes after the window closes.

This optimization significantly reduces the impact on IO response times while still maintaining write-order consistency across the active-active replication ecosystem. The write operations are queued at the host adapter level, allowing the system to maintain write order without requiring the host to stop sending writes. Once the window closes, the queued writes are processed while preserving the point-in-time consistency of the snapshot.

In embodiments, the controller 142 of the local storage array 102 can implement a two-phase snapshot process that minimizes IO impact while maintaining data consistency. During the create phase, the controller 142 prepares volumes for snapshot creation by initializing necessary data structures and setting a pending snapshot indication in fast-access memory for each volume without requiring an ECA window. The controller 142 sends this create command to the remote array 104 and waits for an acknowledgment before completing the create phase.

When entering the activate phase, the controller 142 opens a shortened ECA window and flushes all outstanding IOs to ensure write consistency. It then sets a global indication in memory signaling snapshot activation and coordinates with the remote controller 342 to ensure synchronized activation. Once activation is confirmed on both arrays, the controller 142 closes the ECA window.

For write handling, the controller 142 can first check the pending snapshot indication in fast-access memory. If pending, it checks the global activation indication. For the first write to a volume with pending activation, the controller 142 performs a synchronous write intercept, initializes snapshot data structures, sends an early activation request to the remote controller 342, and preserves existing data before accepting the write. After activation, writes are handled asynchronously using write version handling to preserve old data as deltas.

The controller 142 manages background activation by running a process that sequentially completes snapshot initialization for each volume. As each volume completes, the controller 142 clears its local pending indication. Once all volumes are processed, it clears the global indication.

In embodiments, the remote storage array controller 342 works in coordination with the local controller 142 to maintain consistent snapshots across the active-active replication. Upon receiving the create command from the local controller 142, the remote storage array controller 342 prepares its volumes and sets pending snapshot indications in fast-access memory. The remote controller 342 then sends an acknowledgment back to the local controller 142 to confirm preparation is complete.

During the activation phase, the remote controller 342 receives the activation command and coordinates with the local controller to open its ECA window. It flushes outstanding IOs and sets its global indication flag to signal snapshot activation. The remote controller 342 maintains synchronization with the local controller through acknowledgments, ensuring consistent point-in-time images across both arrays 102/104.

For write operations, the remote controller 342 implements the same checking mechanism as the local controller 142, verifying both pending snapshot and global activation indications. When receiving an early activation request from the local controller 142, the remote controller 342 performs the necessary snapshot activation steps before processing the associated write operation. The remote controller 342 preserves existing data as snapshot deltas before applying new writes to maintain point-in-time consistency.

The remote controller 342 runs its own background activation process in parallel with the local controller 142. This process initializes snapshot data structures for each volume and clears local pending indications as volumes complete. The remote controller 342 maintains its own global indication flag, clearing it once all its volumes have completed activation. Throughout the process, the remote controller 342 coordinates with the local controller 142 to ensure consistent snapshot management across the active-active replication environment 300.

In embodiments, the snapshot creation phase establishes the foundation for taking consistent point-in-time copies across active-active replication arrays (e.g., the arrays 102/104) while minimizing the impact on IO performance. This phase performs the bulk of snapshot initialization work outside of any consistency window, enabling efficient snapshot creation without prolonged write hold times.

During the snapshot creation phase, the controllers 142/342 work together to establish the foundation for consistent snapshots. The local controller 142 initiates the process by sending a create command that prepares volumes for snapshot creation. This preparation includes initializing necessary data structures and adding entries to the snapshot table to store snapshot names.

The local controller 142 then sets a pending snapshot indication in fast-access memory for each volume without requiring an ECA window. This indication serves as a flag that will be checked during subsequent write operations to determine if snapshot activation is needed. Simultaneously, the local controller 142 transmits the create command to the remote controller 342.

Upon receiving the create command, the remote controller 342 performs parallel preparation steps on its volumes. It initializes its own data structures and sets pending snapshot indications in its fast-access memory. The remote controller 342 then sends an acknowledgment back to the local controller 142 to confirm preparation is complete.

The creation phase is designed to perform the bulk of snapshot initialization work outside of any ECA window. This approach significantly reduces the impact on IO performance compared to previous methods that required extended ECA windows. Both controllers 142/342 maintain their pending snapshot indications at the volume level, allowing for efficient checking during subsequent write operations.

The creation phase is completed after both controllers 142/342 have finished their preparation steps and exchanged acknowledgments. This coordination ensures that both arrays 102/104 are properly prepared for the subsequent activate phase while maintaining consistency across the active-active replication environment.

In embodiments, the snapshot activation phase enables near-instantaneous activation of consistent snapshots across active-active replication arrays, while minimizing IO impact through a shortened consistency window and a background initialization process. This phase is critical for maintaining write-order consistency and data integrity while significantly reducing the performance impact compared to previous approaches that required extended consistency windows.

During the activation phase, the local controller 142 initiates the process by opening a shortened consistency window and coordinating with the remote controller 342. Both controllers 142/342 flush all outstanding IOs to ensure write consistency across their respective arrays. The local controller 142 then sets a global indication in memory signaling snapshot activation and sends the activate command to the remote controller 342.

Upon receiving the activate command, the remote controller 342 performs parallel activation steps, setting its own global indication flag. Both controllers 142/342 maintain synchronization through acknowledgments to ensure consistent point-in-time images are established. Once activation is confirmed on both arrays 102/104, the controllers 142/342 close their consistency windows.

For write handling during activation, both controllers 142/342 implement identical checking mechanisms. When a write arrives, the controller 142 checks the pending snapshot indication in fast-access memory and the global activation status. For the first write to a volume with pending activation, the controller 142 performs a synchronous write intercept, initializes snapshot data structures, and coordinates with the remote controller 342 through an early activation request.

The controllers 142/342 manage background activation independently but in parallel. Each controller 142/342 runs a background process that sequentially completes snapshot initialization for its volumes. As each volume completes activation, each controller 142/342 clears its local pending indication. The background process preserves existing data as snapshot deltas before applying new writes, ensuring point-in-time consistency while minimizing impact on IO performance.

Once all volumes have completed activation, each controller 142/342 clears its global indication. This coordinated approach enables controllers 142/342 to maintain consistent snapshots across the active-active replication environment, while significantly reducing the duration of write holds compared to previous methods.

In embodiments, the controllers 142/342 implement a write IO flow that enables efficient handling of write operations during snapshot activation while maintaining data consistency across active-active replication arrays. This flow minimizes IO impact during snapshot operations while ensuring the proper preservation of point-in-time copies, thereby addressing the previous challenge of prolonged write holds during snapshot activation.

When a write command arrives at the local controller 142, it first checks the pending snapshot indication in fast-access memory. If no pending indication exists, the write proceeds normally. However, if the pending indication is set, the controller 142 checks the global indication for the replication group. Upon finding both indications set, the local controller 142 activates the snapshot before accepting the write.

The local controller 142 then sends an early activation request to the remote controller 342. This coordination ensures snapshot consistency across both arrays. Upon receiving the early activation request, the remote controller 342 performs similar checks of its pending snapshot and global indications. If necessary, it activates its snapshot before accepting the replicated write.

During write processing, both controllers 142/342 implement version handling to preserve existing data. Before accepting new writes, the controllers 142/342 preserve the current data as snapshot deltas. This preservation occurs through a synchronous write intercept that initializes snapshot data structures and clears the pending bit. After activation, writes are handled asynchronously, with the write version handling module preserving old data as deltas before applying new data to backend tracks.

The write IO flow ensures that snapshot activation completes before any new writes are processed, maintaining point-in-time consistency while minimizing impact on IO performance. This approach allows both controllers 142/342 to coordinate snapshot activation efficiently while handling ongoing write operations, significantly reducing the duration of write holds compared to previous methods that required extended consistency windows

In embodiments, the controllers 142/342 can implement a background activation flow that enables efficient snapshot initialization across active-active replication arrays 102/104 by moving time-consuming data structure initialization operations outside the consistency window. This approach minimizes IO impact while maintaining data consistency, addressing the previous challenge of requiring all initialization to occur during extended consistency windows.

During background activation, the local controller 142 initiates a background process that sequentially activates snapshots for each volume in its array 102. For each volume with a pending snapshot indication, the controller initializes all necessary data structures, which can take several seconds per volume. After completing initialization for a volume, the controller 142 clears that volume's local pending snapshot indication, allowing subsequent writes to proceed without synchronous intercepts.

The remote controller 342 simultaneously runs its own parallel background process, performing the same initialization steps for its volumes. Both controllers 142/342 maintain coordination while independently processing their volumes, ensuring consistent snapshot management across the active-active replication environment 300. As each volume completes activation, its local pending indication is cleared, enabling efficient write handling.

During this background activation phase, both controllers 142/342 preserve existing data as snapshot deltas before applying new writes to maintain point-in-time consistency. The background processes continue until all volumes have been fully activated. Once all volumes are processed, each controller 142/342 clears its global indication flag. This coordinated approach enables controllers 142/342 to complete the intensive initialization work without impacting IO performance while maintaining consistency across both arrays 102/104.

The background activation flow significantly improves scalability by allowing snapshot management to occur without delaying foreground operations. This optimization enables the controllers 142/342 to handle large numbers of volumes efficiently while maintaining the consistency guarantees required for database restartability.

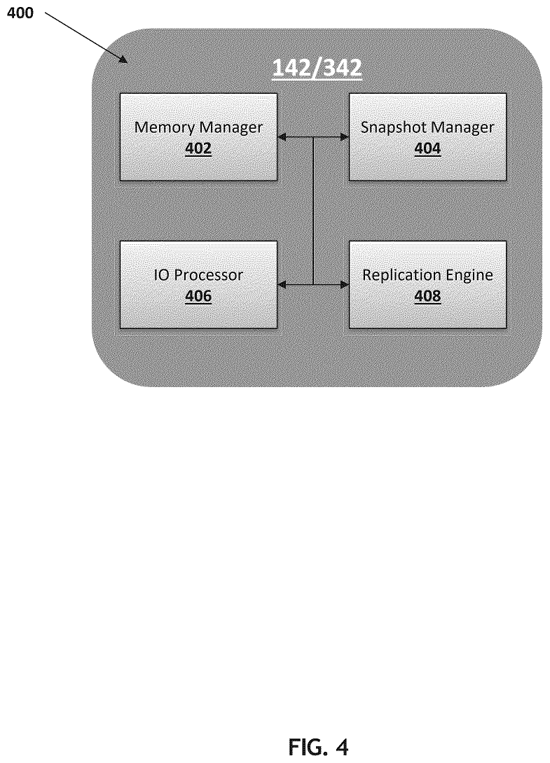

Regarding FIG. 4, a storage array (e.g., the storage array 102 of FIG. 1) can include a controller 142/342, including logic, hardware, and circuitry 400 that optimizes snapshot creation in active-active storage replication environments.

In embodiments, the controller 142/342 can include a memory manager 402 that implements a two-tier memory structure for managing snapshot indications across active-active replication arrays. The memory manager 402 maintains both fast-access local memory for per-volume pending snapshot indications and global memory for activation status across replication groups.

For local memory management, the memory manager 402 allocates and maintains dedicated faster-access memory regions for each volume in the storage arrays. During snapshot creation, it sets pending-snapshot indication bits in these local memory regions without requiring an Enginuity Consistency Assist (ECA) window, allowing for efficient checking of snapshot status during write operations.

The ECA window represents a critical period during storage operations where write operations are temporarily queued at the host adapter level to ensure write-order consistency across volumes in a replication group. During this period, the storage array continues to receive incoming writes but does not acknowledge or process them until the ECA window closes.

Minimizing or eliminating ECA window usage provides several significant advantages for storage system performance. The traditional approach, which requires extended ECA windows, substantially degrades IO response times during snapshot operations, as writes must be held in queues for longer durations. By moving initialization tasks outside the ECA window, the controller 142/342 maintains higher performance levels of the storage arrays during snapshot creation and activation.

The impact on write operations is notably reduced in the new approach. Where previously writes would be held for extended periods creating potential bottlenecks, the controller 142 now requires only a brief ECA window specifically for flushing outstanding IOs. This shorter interruption period significantly improves overall system responsiveness.

System scalability benefits substantially from minimizing ECA window usage. The previous implementation required maintaining ECA windows across numerous devices in replication groups, which compounded performance impacts as the system scaled. The new solution performs most operations outside the ECA window, enabling better scaling across larger device groups.

Write-order consistency remains fully preserved despite the reduced ECA window duration. The controller 142/342 maintains data integrity through careful coordination of snapshot operations and write handling while significantly reducing the performance impact traditionally associated with consistency maintenance.

The optimization of background processing represents another key advantage. By relocating initialization tasks to background processes outside the ECA window, the controller 142/342 achieves consistent snapshot creation without requiring extended write-holding periods. This approach ensures the proper creation of snapshots while maintaining system performance and responsiveness.

In global memory management, the memory manager 402 maintains indication bits that signal snapshot activation status across entire replication groups. This global indication is set during the activate command phase and serves as a coordination mechanism between the active-active arrays (e.g., the local array 102 and the remote storage array 104, as shown in FIG. 3).

In embodiments, the memory manager 402 implements an optimized memory access pattern where write operations first check the local pending indication in fast-access memory before accessing global memory indications. This two-step verification process minimizes performance impact by avoiding unnecessary global memory accesses.

For cleanup operations, the memory manager 402 coordinates with one or more background activation processes to clear pending indications. It clears local pending bits on a per-volume basis as individual volumes complete activation and manages the clearing of global indication bits once all volumes in a replication group have completed activation.

In embodiments, the background activation processes run independently on both active-active replication arrays after the snapshot activate command completes. These processes handle the time-consuming task of initializing data structures for volumes with pending snapshot indications without impacting host IO performance.

During background activation, the processes systematically activate snapshots for each volume in the replication group. For each volume, the processes initialize all necessary data structures and then clear the local pending snapshot indication specific to that volume. This per-volume activation approach allows the controller 142/342 to maintain consistency while minimizing the impact on ongoing operations.

The background processes can operate asynchronously, taking several seconds to complete the full initialization across all volumes. During this time, any write operations to volumes with pending activations are intercepted and handled through a synchronous activation process to ensure data consistency.

A feature of background activation is its coordination across both arrays in the active-active pair. The processes run simultaneously on both arrays, with each array handling its local volume activations independently. This parallel processing approach helps maintain performance while ensuring consistency across the replication pair.

Once all volumes have completed activation and had their local pending bits cleared, the background processes clear the global indication on both arrays. This final step indicates that snapshot activation is complete, allowing subsequent write operations to proceed without requiring snapshot-related intercepts.

This background activation approach represents a significant improvement over previous methods by relocating the bulk of snapshot initialization work outside the ECA window, thereby reducing the impact on host IO operations while maintaining data consistency across the active-active replication environment (e.g., the environment 300 of FIG. 3).

In embodiments, the memory manager 402 also supports the versioning of write operations by maintaining memory structures that preserve existing data before accepting new writes. This ensures data consistency while minimizing the impact on IO response times during snapshot operations.

Through these capabilities, the memory manager 402 enables the efficient implementation of consistent snapshots across active-active remote replication arrays while significantly reducing the duration of required ECA windows compared to previous approaches

In embodiments, the controller 142/342 can include a snapshot manager 404 that implements a two-step snapshot process for active-active remote replication arrays, maintaining data consistency while minimizing performance impact. The snapshot manager 404 coordinates snapshot operations across both storage arrays through create and activate commands.

During the create phase, the snapshot manager 404 prepares volumes for point-in-time image creation by initializing necessary data structures and setting pending snapshot indications in fast-access memory on both arrays. This preparation occurs outside the ECA window to minimize the impact on ongoing operations.

For the activate phase, the snapshot manager 404 coordinates a brief ECA window across both arrays to ensure write-order consistency. During this window, the snapshot manager 404 flushes outstanding IOs and sets global memory indications to signal snapshot activation. This approach significantly reduces the traditional ECA window duration while maintaining consistency.

The snapshot manager 404 implements sophisticated write handling during activation. It intercepts write operations to volumes with pending snapshots and coordinates with the remote array through early activation requests. The snapshot manager 404 ensures proper snapshot initialization before allowing writes to proceed, preserving existing data through versioning when necessary.

For background processing, the snapshot manager 404 orchestrates the initialization of snapshot data structures across all volumes with pending indications. This background activation process runs independently on both arrays, systematically activating snapshots for each volume while clearing local pending bits upon completion. Once all volumes are processed, the snapshot manager 404 coordinates the clearing of global indication bits.

The snapshot manager 404 also maintains a snapshot table, storing snapshot names and managing entries for point-in-time images. It ensures proper coordination between local and remote arrays for consistent snapshot creation and activation, supporting both manual and scheduled snapshot operations.

Through these capabilities, the snapshot manager 404 enables the efficient creation of identical, consistent snapshots across active-active remote replication arrays while significantly reducing the performance impact traditionally associated with snapshot operations.

In embodiments, the controller 142/342 can include an IO processor 406 that manages write operations and snapshot-related IO handling across active-active replication arrays while maintaining data consistency and minimizing performance impact. The processor 406 implements sophisticated write handling mechanisms during both normal operations and snapshot activation periods.

During snapshot operations, the IO processor 406 coordinates with the Enginuity Consistency Assist (ECA) window to manage write operations. When the ECA window opens, the IO processor 406 queues incoming writes at the host adapter level without acknowledging them, ensuring write-order consistency across volumes. The processor then systematically flushes outstanding IO operations before proceeding with snapshot activation.

For write handling during snapshot activation, the IO processor 406 implements a two-phase verification process. First, it checks the pending snapshot indication in fast-access memory, followed by verifying the global indication for the replication group. When both indications are set, the IO processor 406 coordinates snapshot activation before processing the write operation.

The IO processor 406 manages early activation requests between arrays when write operations arrive during snapshot activation. Upon receiving a write on one array while snapshot activation is pending, the processor 406 sends an activation request to the remote array to ensure consistent snapshot creation across both arrays.

For data preservation, the IO processor 406 implements versioning mechanisms to maintain write-order consistency. Before accepting new write operations, the processor 406 preserves existing data as snapshot deltas, ensuring that point-in-time images remain consistent. This versioning approach allows for efficient handling of writes while maintaining snapshot integrity.

After snapshot activation completes, the IO processor 406 transitions to asynchronous write handling, where the write version handling module preserves old data as deltas before applying new data to backend tracks. This approach optimizes performance while ensuring data consistency across the active-active replication environment.

Through these capabilities, the IO processor 406 enables efficient write handling and snapshot operations while significantly reducing the performance impact traditionally associated with consistent snapshot creation in active-active remote replication environments

In embodiments, the controller 142/342 can include a replication engine 408 that manages the coordination of snapshot operations and data consistency between active-active replication arrays while minimizing performance impact. The engine 408 implements sophisticated protocols for handling both snapshot creation and activation across the paired storage arrays.

During snapshot creation, the replication engine 408 coordinates the preparation of volumes across both arrays, ensuring that pending snapshot indications are properly set in fast-access memory on each array. This coordination occurs outside the ECA window to maintain system performance while establishing the foundation for consistent snapshots.

For snapshot activation, the replication engine 408 manages a brief ECA window across both arrays to ensure write-order consistency. During this window, the engine 408 coordinates the flushing of outstanding IOs and the setting of global memory indications to signal snapshot activation status. This approach significantly reduces the traditional ECA window duration while maintaining consistency across the replication pair.

The replication engine 408 implements early activation request handling between arrays when write operations arrive during snapshot activation. Upon receiving a write on one array while snapshot activation is pending, the engine 408 sends an activation request to the remote array to ensure consistent snapshot creation. This coordination ensures proper snapshot initialization before allowing writes to proceed.

For write handling, the replication engine 408 manages the replication of write operations between arrays while maintaining snapshot consistency. The engine 408 ensures that writes are properly versioned and that existing data is preserved as snapshot deltas before applying new data to backend tracks. This approach optimizes performance while ensuring data consistency across the active-active replication environment.

Through these capabilities, the replication engine 408 enables the efficient creation of identical, consistent snapshots across active-active remote replication arrays while significantly reducing the performance impact traditionally associated with snapshot operations. The engine's coordination of snapshot operations and write handling ensures data integrity while maintaining system responsiveness.

Although what is described herein shows details of logic, hardware, and circuitry 400 that may reside in the controller 142/342, all or portions of the illustrated components may also reside elsewhere in the storage array (e.g., one or more of the storage array's components 108 of FIG. 1).

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

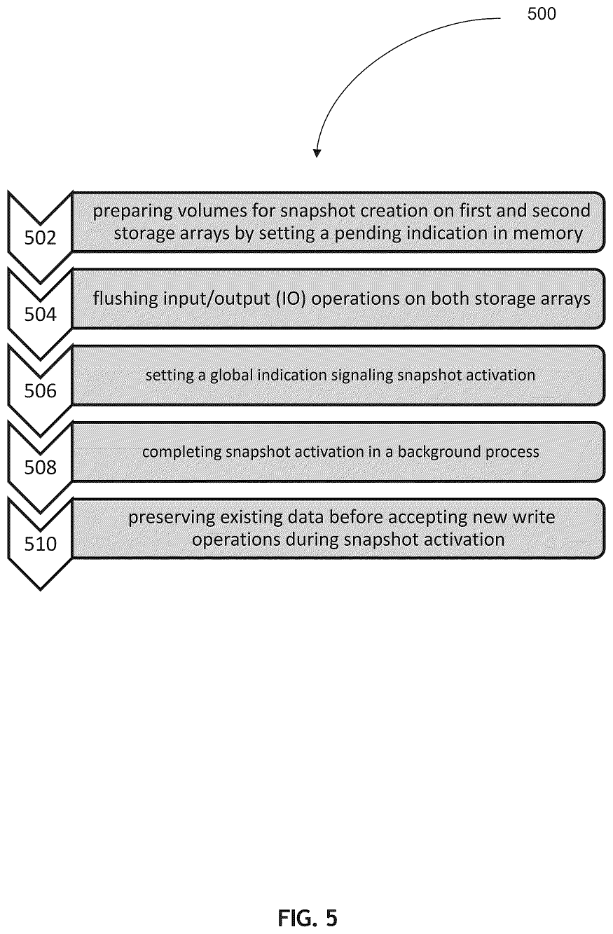

Regarding FIG. 5, a method 500 relates to optimizing snapshot creation in active-active storage replication environments. In embodiments, the controller 142 of FIG. 1 can perform all or a subset of operations corresponding to the method 500.

For example, the method 500, at 502, can include preparing volumes for snapshot creation on first and second storage arrays by setting a pending indication in memory. Additionally, at 504, the method 500 can include flushing input/output (IO) operations on both storage arrays. Furthermore, the method 500, at 506, can include setting a global indication to signal snapshot activation. At 508, the method 500 can include completing snapshot activation in a background process. The method 500, at 510, can also include preserving existing data before accepting new write operations during snapshot activation.

Furthermore, each operation can include any combination of techniques described in the embodiments herein. Additionally, one or more components 108 of the storage array 102 can implement one or more of the operations described in each of the methods above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
preparing volumes for snapshot creation on first and second storage arrays by setting a pending indication in memory;
flushing input/output (IO) operations on both storage arrays;
setting a global indication signaling snapshot activation;
completing snapshot activation in a background process; and
preserving existing data before accepting new write operations during snapshot activation.

2. The method of claim 1, further comprising:
initializing data structures for snapshot creation on both storage arrays.

3. The method of claim 1, further comprising:
intercepting write operations to the volumes during snapshot activation.

4. The method of claim 1, further comprising:
sending an activation request to the second storage array upon receiving a write operation at the first storage array.

5. The method of claim 1, further comprising:
initializing snapshot data structures for each volume having the pending indication.

6. The method of claim 1, further comprising:
clearing the pending indication for each volume after completing snapshot activation for that volume.

7. The method of claim 1, further comprising:
clearing the global indication after completing snapshot activation for all volumes.

8. The method of claim 1, further comprising:
performing synchronous write intercepts before accepting a first write operation on at least one subject volume of the volumes to initiate a pending snapshot activation.

9. The method of claim 1, further comprising:
handling write operations asynchronously after snapshot activation by preserving old data before applying new data.

10. The method of claim 1, further comprising:
checking the pending indication and global indication before accepting write operations, wherein the pending indication corresponds to a local pending indication and wherein checking the pending indication and the global indication includes referring to the global indication in response to determining the local pending indication is set.

11. An apparatus with a memory and processor, the apparatus configured to:
prepare volumes for snapshot creation on first and second storage arrays by setting a pending indication in memory;
flush input/output (IO) operations on both storage arrays;
set a global indication signaling snapshot activation;
complete snapshot activation in a background process; and
preserve existing data before accepting new write operations during snapshot activation.

12. The apparatus of claim 11, further configured to:
initialize data structures for snapshot creation on both storage arrays.

13. The apparatus of claim 11, further configured to:
intercept write operations to the volumes during snapshot activation.

14. The apparatus of claim 11, further configured to:
send an activation request to the second storage array upon receiving a write operation at the first storage array.

15. The apparatus of claim 11, further configured to:
initialize snapshot data structures for each volume having the pending indication.

16. The apparatus of claim 11, further configured to:
clear the pending indication for each volume after completing snapshot activation for that volume.

17. The apparatus of claim 11, further configured to:
clear the global indication after completing snapshot activation for all volumes.

18. The apparatus of claim 11, further configured to:
perform synchronous write intercepts before accepting a first write operation on at least one subject volume of the volumes to initiate a pending snapshot activation.

19. The apparatus of claim 11, further configured to:
handle write operations asynchronously after snapshot activation by preserving old data before applying new data.

20. The apparatus of claim 11, further configured to:
check the pending indication and global indication before accepting write operations, wherein the lending indication corresponds to a local pending indication and wherein checking the pending indication and the global indication includes referring to the global indication in response to determining the local pending indication is set.
